(19) United States
(12) Patent Application Publication
(10) Pub. No.: US 2026/0113250 A1
(43) Pub. Date: Apr. 23, 2026

(54) INTEGRATED PROCESSING ARCHITECTURE FOR A PIPELINE OF LLM INFERENCE SERVICES WITH A 5G NETWORK

(71) Applicant: ILIAD, Paris (FR)

(72) Inventors: Khaled Sayad, Paris (FR); Patrick Escande, Paris (FR)

(21) Appl. No.: 19/313,457

(22) Filed: Aug. 28, 2025

(30) Foreign Application Priority Data
Oct. 23, 2024 (EP) 24315493.7

(51) Int. Cl. H04L 41/16; H04L 41/083; H04L 41/342; H04L 41/5051; H04L 41/5054

(52) U.S. Cl. CPC H04L 41/16; H04L 41/083; H04L 41/342; H04L 41/5051; H04L 41/5054

(57) ABSTRACT

This architecture comprises a radio access network, a distributed network of User Plane Functions, UPFs, and a core network control plane comprising 5G functions according to 3GPP. It comprises a metacontroller with an on-demand service register, including at least an LLM inference service adapted to be deployed on demand or on an automated basis, a centralized orchestrator, a life-cycle manager, for instantiating, monitoring, updating, scaling and/or terminating the inference services, and a request operator. The UPF distributed network is dynamically programmable and the centralized orchestrator comprises: means for continuously monitoring the 5G network, adapted to analyze user requests to derive therefrom user profiles and LLM inference service usage models; means for, based on the obtained user profiles and LLM inference service usage models, dynamically selecting suitable resources, dynamically modifying the 5G network configuration by interacting with the UPFs, and/or programming the UPFs for local execution of specific tasks related to the LLM inference by modifying packets from and/or to the UEs; and means for generating the service requests to the request operator.

The invention relates to fifth generation (5G) mobile cellular networks, in particular to an architecture specifically adapted to processing interactions between user equipments (UEs) and resources associated with inference services based on Large Language Models (LLMs).

In the present disclosure, the term “users” refers not only to physical persons connected to the 5G network using a smartphone as a UE, but also and above all to autonomous hardware devices such as, for example, autonomous robots or surveillance cameras, connected to the 5G cellular network and which profile has already been entered in a user database of the 5G core network.

### STATE OF THE ART

The starting point for the invention is the observation that these various users are liable to send requests to LLM inference services, wherein such requests are likely to be produced in very large numbers and at relatively high rates, in particular in the case of autonomous hardware devices.

In the case of 5G networks interfaced with LLM inference services (AI-oriented 5G networks), these must be optimised to reduce the latency and ensure a high rate, for example to process a very high number of tokens per request.

An LLM-based inference service operates by running a pre-trained model to process user tokens and generate corresponding outputs. This process may be further optimized using known techniques such as Recovery-Augmented Generation (RAG), cache optimisation, LLM routing, etc.

The invention aims to propose an integrated processing architecture for a pipeline of LLM inference services that optimises both the network resources and the LLM inference services, in order to efficiently manage the available resources, maximize the quality of service (QoS), reduce the costs and improve the overall energy efficiency of the whole.

The object of the invention is to propose for that purpose processes, architectures and tools for better adapting 5G networks to the management of theses new classes of traffic generated by the LLM inference services.

### DISCLOSURE OF THE INVENTION

The basic idea behind the invention is to take advantage of the distributed architecture and management flexibility of 5G networks, which are cloud-native networks, to offer LLM inference services which are effective in terms of cost and energy.

More precisely, in that context, the basic idea behind the invention consists in dynamically, i.e. based on the user behaviour, adapting the 5G network to meet the specific needs of the users, using the well-known principles of Network Functions Virtualisation (NFV) and Software Defined Networks (SDNs), for transforming the LLM optimization requirements into network configurations to be automatically and dynamically integrated to the 5G network.

In other words, the matter is to propose an integrated architecture that optimises both the network resources and the LLM inference services in a 5G environment by exploiting the “cloud-native” programming and orchestration capabilities in order to improve latency, maximise QoS, reduce implementation and operation costs and eventually improve the whole energy efficiency of the system.

In the case mentioned hereinabove of improving the LLM inference service by operations such as RAG, cache optimisation, LLM routing, etc., the invention will advantageously allow implementation of distributed learning, in which these computationally intensive operations are carried out in the central cloud to avoid deploying them in edge environments that, while being close to the final users, could compromise the performances due to limitations on the computing resources at edge level.

According to the invention, it becomes possible to exploit network computing in the context of an AI-oriented 5G network to offload such operations, which consume large amounts of computing resources, to network elements (and no longer to edge or cloud resources), especially to User Plane Functions (UPF) of the 5G network, the user plane also acting as a data transport plane for routing data packets to/from the UEs between the UEs and the 5G core network control plane.

According to the invention, this UPF distributed network is a network that can be dynamically programmed by a life-cycle manager in charge of instantiating, monitoring, updating, scaling and/or terminating the LLM inference services, so as to dynamically modify, in real time, the UPF network via the core network control plane.

Such an architecture, in which the optimisation operations (RAG, cache optimisation, LLM routing, . . . ) are executed at the user plane and the data plane close to the users, takes advantage of the availability of the behavioural data for these users, because they are connected to the 5G network and thus directly to the user and data plane. It is therefore possible to easily derive user profiles and LLM inference service usage models of a given user or group of users, and thus to determine more contexts to be used for example for the RAG, or to optimise the cache for a cluster of 5G UEs sharing usage similarities.

It is also possible to use this arrangement to offload certain LLM inference operations to network elements at the user plane/data plane, which reduces accordingly the amount of edge or cloud resources needed to process the LLM requests.

For that purpose, the inference more precisely proposes an integrated processing architecture for a pipeline of inference services based on LLMs with a 5G network, comprising, in a manner known per se: a radio access network, for radiofrequency communication with user equipments, UEs; a distributed network of User Plane Functions, UPFs, also acting as a data transport plane for routing data packets to/from the UEs; and a core network control plane comprising 5G functions according to 3GPP.

Characteristically of the invention, this architecture further includes a metacontroller comprising: an on-demand service register, including at least an LLM inference service adapted to be deployed on demand or on an automated basis; a centralized orchestrator, adapted to cooperate, on the one hand, with the core network control plane, and on the other hand, with the on-demand service register; a life-cycle manager, for instantiating, monitoring, updating, scaling and/or terminating the inference services; and a request operator, for providing, to the at least one LLM inference service of the on-demand service register, service requests generated by the centralized orchestrator.

The UPF distributed network is a network that can be dynamically programmed by the centralized orchestrator, on demand from the life-cycle manager, via the core network control plane.

The centralized orchestrator comprises: means for continuously monitoring the 5G network, adapted to analyze user requests produced by the UEs, to derive therefrom user profiles and LLM inference service usage models; means for, based on the obtained user profiles and LLM inference service usage models: dynamically selecting resources based on the user profiles and LLM inference service usage models, dynamically modify the 5G network configuration by interacting with the UPFs, and/or programming the UPFs for local execution of specific tasks related to the LLM inference by modifying packets from and/or to the UEs; and means for generating the service requests to the request operator.

According to various subsidiary advantageous features:
to automatically derive the user profiles and the LLM inference service usage models, the 5G network continuous monitoring means of the centralized orchestrator comprise processor means cooperating with a database implemented with machine learning algorithms;
the at least one LLM inference service comprises at least one service among: a LCaaS service of LLM caches per language model, for a dynamic and optimum orchestration of the LLM application caches through the edge network in order to reduce the request latency; an eCaaS service of dynamic bandwidth allocation for the 5G radio resources, for adapting the bandwidth to the LLM usage regime and the predefined downlink/uplink/downlink&uplink traffic classes based on the specific UEs needs; an INFaaS service of customized LLM inference for the UEs; a GRaaS service of LLM guardrail management, to reinforce user request confidentiality; and/or a LRaaS service of routing the user requests produced by the UEs to the most suitable language model for reducing the latency and/or improving the quality of service, QoS, and/or the relevance of answers to user requests; and any combination of the above; the LLM inference services are descriptive files of an Infrastructure as Code, IaC, type;
the service requests generated by the centralized orchestrator (220) and the request operator implement Containerized Network Functions, CNFs, corresponding to the LLM inference services included in the on-demand service register;
the CNFs corresponding to the LLM inference services are operated in a Network Functions Virtualisation, NFV, architecture, based on ETSI specifications;
the UPF distributed network is an heterogeneous network comprising: UPFs of main switching/routing function, and/or UPFs comprising, in addition to the switching/routing functions, adjustable user-request pre-processing functions specific to the LLM applications;
the UPF distributed network is a network comprising a dynamically adjustable number of UPFs;
the UPFs are developed as micro-services deployed in cloud infrastructures in containers orchestrated by a container orchestrator; the UPFs are programmed in P4 language;
the 5G network, the centralized orchestrator and the on-demand service register are implemented as containerized functions, which instantiation and life-cycle management on data center hardware infrastructure are managed by a container orchestrator;
the above-mentioned container orchestrator is advantageously a Kubernetes solution, and the 5G network is an open source solution of a Free5gc or sd-core type;
the user profiles and the LLM inference service usage models comprise at least one among: frequency of use; content popularity; location and/or geographic mobility of the UEs; quality of service, QoS, constraint; latency constraint; and/or interactions with other UEs; and any combination of the above;
said specific tasks related to the LLM inference executed locally by the UPFs comprise at least one among: Recovery-Augmented Generation, RAG; dynamic optimisation of user caches ; specific routing of the user requests; calculation of similarity usage metrics between UEs; clustering of input and/or output similar UE data; and/or LLM inference operation; and any combination of the above;
the UEs are equipment devices of the group comprising smartphones, autonomous robots and/or video surveillance cameras, comprising a circuit for connection to the 5G network and which profile has already been entered into a core network user database.

### BRIEF DESCRIPTION OF THE DRAWINGS

FIG. 1 is an overview, in the form of a block diagram, of the various functional elements of the processing architecture of a pipeline of LLM inference services by a 5G network according to the invention.

### DETAILED DESCRIPTION OF EMBODIMENTS OF THE INVENTION

An exemplary embodiment of the invention will now be described, with reference to the appended drawing.

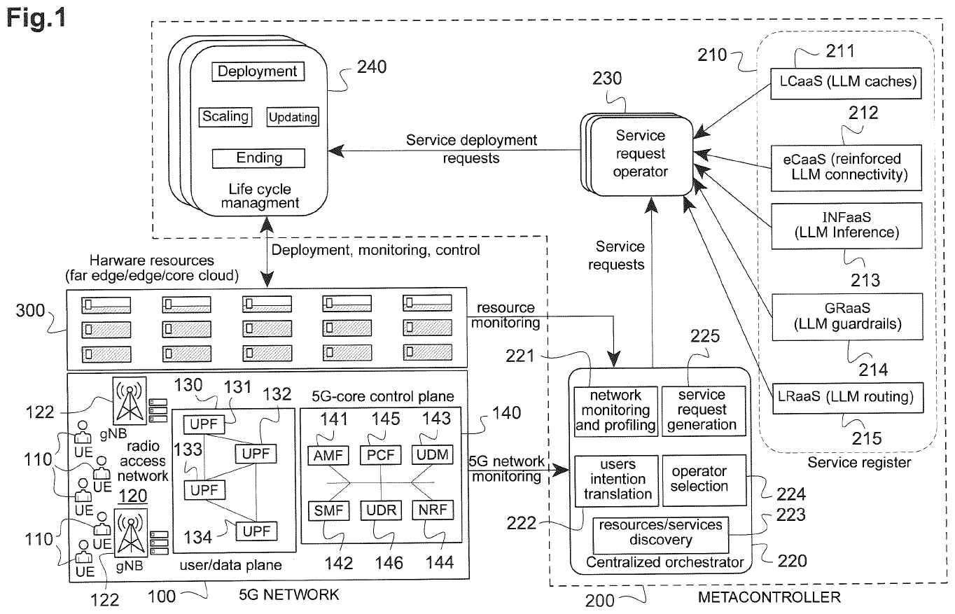

In FIG. 1, reference 100 denotes the main components, known per se, of a 5G network, reference 200 generally denotes a metacontroller, characteristic of the invention to achieve the purposes mentioned hereinabove in introduction, and reference 300 as a whole denotes hardware resources (servers, datacenters, etc.) used by the 5G network 100 and the metacontroller 200 in a delocalized, near, or remote way (resources called “far edge”, “edge”, “core cloud”, etc. depending on the case). Said hardware resources are known per se, both in their structure and in the way they are accessed, and are not in themselves changed for the purposes of implementing the invention.

The network 100 is a 5G mobile network, this term being understood in the specific sense defined by the standardisation bodies, in particular 3GPP. It will be the same for the different components of this 5G network mentioned in the present disclosure, such as “UPF”, “transport plane/data plane”, “control plane”, “core network”, etc., which must be understood in their specific sense, as understood by a person skilled in the art of mobile communication networks.

Reference 110 denotes user equipments, UEs, used to wirelessly exchange information with the 5G network. As mentioned hereinabove, these users may be physical persons as well as purely autonomous hardware equipment devices such as robots or cameras, which profile has already been entered into the 5G network.

The 5G network comprises a radio access network part 120 with a number of base stations 122, denoted gNB in the 5G network nomenclature.

The radio access network 120 is interfaced to a distributed network 130 of User Plane Functions, UPFs in the 5G network nomenclature, 131, 132, 133, 134, . . . , the user plane also acting as a data transport plane for routing data packets from and the UEs 110.

The user plane/data plane 130 is interfaced to a core network control plane 140 (5G-core), including the functions and resources such as:
AMF 141: Access and Mobility-management Function;
SMF 142: Session-Management Function;
UDM 143: User-Data Management;
NRF 144: Network-function Repository Function;
PCF 145: Policy-Control Function;
UDR 146: User-Data Repository, this repository storing in particular
the identity and profile of the different UEs known from the network.

Characteristically of the invention, the 5G network is associated with a metacontroller 200, intended to dynamically orchestrate and optimize the cloud resources and the 5G network functions based on the 5G network state and the needs of the LLM inference services at any given time.

The metacontroller 200 comprises a service register 210 that includes the different LLM inference services implemented by the invention, in particular and in a non-limiting way:
a LCaaS service 211 of LLM caches per language model, for a dynamic and optimum orchestration of the LLM application caches through the edge network in order to reduce request latency;
an eCaaS service 212 of dynamic bandwidth allocation for the 5G radio resources, for adapting the bandwidth to the LLM usage regime and to the predefined downlink/uplink/downlink&uplink traffic classes based on the specific UEs needs;
an INFaaS service 213 of customized LLM inference for the UEs;
a graas service 214 of LLM guardrail management, to reinforce user
request confidentiality;
a LRaaS service 215 of routing the user requests produced by the UEs to the most suitable language model, for reducing the latency and/or improving the quality of service, QoS, and/or the relevance of answers to user requests.

Very advantageously, these LLM inference services are descriptive files of the Infrastructure as Code (IaC) type, making it possible to manage a virtual infrastructure by means of descriptor files, avoiding the implementation of programming API interfaces specific to each application.

The metacontroller 200 also comprises a centralized orchestrator 220 that continuously monitors the 5G network elements, the users behaviour, and the data centers resources.

This centralized orchestrator performs essentially the tasks of:
network monitoring and profiling, by detecting user behaviour for triggering orchestration of the network resources (block 221);
translation of user intentions, for adapting network configurations based on the LLM service usage models (block 222);
resource and service discovery, with dynamic management of the services and resources available in the network to optimize the use thereof (block 223);
operator selection, with choice of the service to be integrated to answer the QoS requirements of the users (block 224); and service request generation, with creation of service requests to a service request operator 230 (block 225).

As regards user profiles and LLM inference service usage models (block 222), these may comprise, in particular and in a non-limiting way, the following parameters:
frequency of use;
content popularity;
location and/or geographic mobility of the UEs;
QoS constraint;
latency constraint;
interactions of the UEs with other UEs.

To automatically derive these user profiles and LLM inference service usage models (block 222), the continuous monitoring of the 5G network (block 221) advantageously implements algorithms of the machine learning type operating based on a knowledge base that has been built up in advance and is constantly updated.

The service requests generated by the centralized orchestrator 220 are applied to a service request operator 230 interfaced with the LLM inference service register 210 and to a life-cycle manager 240.

The service requests generated by the centralized orchestrator 220 will enable to deploy the required LLM inference services by avoiding potential conflicts between controllers.

The life-cycle manager 240 is in charge of instantiating, monitoring, updating, scaling and/or terminating the deployed services.

Advantageously, the requests generated by the centralized orchestrator 200 and by the service requests operator 230 implement Containerized Network Functions (CNF) corresponding to the LLM inference services included in the service register 210.

These CNFs are advantageously operated in a Network Functions Virtualisation (NFV) architecture based on ETSI specifications.

Likewise, the 5G network 100, the centralized orchestrator 220 and the service register 210 are advantageously implemented as containerized functions, which instantiation and life-cycle management on the hardware infrastructure 300 are managed by a container orchestrator.

This container orchestrator may in particular be a Kubernetes solution, the 5G network being an open source solution of the Free5gc or sd-core type (Aether project).

The LLM inference copies, or model fragments, for example answer caches or light models, are placed in the UPFs 131, 132, 133, 134, . . . , distributed in the 5G network 100, so as to process locally the user requests and thus reduce the latency.

It is reminded that, in 5G networks, the user/data plane is a programmable plane, which makes it possible to configure directly and dynamically the UPFs to execute specific tasks related to the LLM inference.

The specific tasks, locally executed by the UPFs 131, 132, 133, 134, . . . may comprise, in particular and in a non-limiting way:
recovery-augmented generation (RAG);
dynamic optimisation of user caches;
specific routing of the user requests;
calculation of similarity usage metrics between UEs;
clustering of similar input and/or output UE data;
LLM inference operation.

By distributing the processing load of the inferences through several UPFs, the load is equilibrated and bottlenecks are avoided. Likewise, using the UPFs to process some parts of the inferences directly in the network, the need to transmit all the requests to remote data centers is reduced, thus saving the bandwidth and reducing the energy consumption. Finally, thanks to the centralized orchestration, the 5G network may adjust in real time the distribution of the language models based on both (i) the user behaviour and (ii) conditions of the network at a given time, thus ensuring an optimum performance in any circumstances.

The UPFs in charge of these tasks are preferably developed as micro-services deployed in cloud infrastructures in containers orchestrated by a container orchestrator.

Preferably, the UPFs are programmed to meet the following requirements, which may be achieved in particular with a programming language such as the P4 language:
advanced programmability: indeed, P4 allows the data plan to be programmed in a flexible and customised way. By combining with P4 an open source solution such as Aether mentioned hereinabove, it is possible to define and modify dynamically the way the data packets are processed in the network, which is crucial for meeting the specific requirements of the LLM inference services;
support of high-performance UPF specification: compatibility with P4 makes it possible to take full advantage of the UPF's capabilities in Aether, optimising packet processing directly in the network with the possibility, as indicated hereinabove, to locally implement functionalities such as cache optimization, LLM routing, etc. and other complex operations required for the inference services;
flexibility of the control plane and the data plane: P4 offers a great flexibility for programming not only the data plane 130, but also to interact finely with the control plane 140. This flexibility is exploited in Aether to create highly adapted and optimized network solutions, in particular for the demanding applications such as those based on LLM inference.

To sum up, the network adapts in real time to user needs and optimizes the resources in order to offer LLM inference services with a minimum latency and a maximum efficiency.

For its part, the use of an open source solution such as Aether for the 5G network offers the following advantages:
possibility of execution on a Kubernetes environment, that simplifies integration of other Kubernetes services and facilitates the orchestration and management of the network resources in coherence with the other services deployed in the infrastructure;
support of high-performance UPF specification, with the above-mentioned advantages such as high programmability of both the control and data planes and efficient management of the data traffic enabling to benefit from ultra-low latency and high-rate data transfer.

Moreover, the UPF distributed network 130 is a network that may comprise a variable number of UPFs, dynamically adjustable based on the instantaneous network and users needs.

Finally, it is possible to group and combine UPFs 131, 132, 133, 134, . . . of different categories in the same user plane 130, for example:
UPFs liable to support high data traffic volumes, which main function will be the data traffic switching/routing between the UEs and the public Internet. This function may be for example modelled by a finite state machine which data packets pass through predefined and fixed processing blocks;
UPFs that operate close to the UEs, which data packet processing chain applied by the radio access network is adjustable and comprises, in addition to the routing/switching functions, functions for pre-processing requests to LLM applications, these functions belonging to inference LRaaS (LLM routing) and LCaaS (LLM caches) services and being implementable on demand.

1. An integrated processing architecture for a pipeline of inference services based on Large Language Models, LLMs, with a 5G network, comprising:
a radio access network, for radiofrequency communication with user equipments, UEs;
a distributed network of User Plane Functions, UPFs, also acting as a data transport plane for routing data packets to/from the UEs;
a core network control plane comprising 5G functions according to 3GPP; and
a metacontroller comprising:
an on-demand service register, including at least an LLM inference service adapted to be deployed on demand or on an automated basis;
a centralized orchestrator, adapted to cooperate, on the one hand, with the core network control plane, and on the other hand, with the on-demand service register;
a life-cycle manager, for instantiating, monitoring, updating, scaling and/or terminating the inference services; and
a request operator, for providing, to the at least one LLM inference service of the on-demand service register, service requests generated by the centralized orchestrator,
wherein the UPF distributed network is a network that can be dynamically programmed by the centralized orchestrator, on demand from the life-cycle manager, via the core network control plane,
and wherein the centralized orchestrator comprises:
means for continuously monitoring the 5G network, adapted to analyze user requests produced by the UEs, to derive therefrom user profiles and LLM inference service usage models;
means for, based on the obtained user profiles and LLM inference service usage models:
dynamically selecting resources based on the user profiles and LLM inference service usage models,
dynamically modifying the 5G network configuration by interacting with the UPFs, and/or
programming the UPFs for local execution of specific tasks related to the LLM inference by modifying packets from and/or to the UEs; and
means for generating the service requests to the request operator.

2. The processing architecture of claim 1, wherein, to automatically derive the user profiles and the LLM inference service usage models, the 5G network continuous monitoring means of the centralized orchestrator comprise processor means cooperating with a database implemented with machine learning algorithms.

3. The processing architecture of claim 1, wherein the at least one LLM inference service comprises at least one service among:
a LCaaS service of LLM caches per language model, for a dynamic and optimum orchestration of the LLM application caches through the edge network in order to reduce the request latency;
an eCaaS service of dynamic bandwidth allocation for the 5G radio resources, for adapting the bandwidth to the LLM usage regime and the predefined downlink/uplink/downlink&uplink traffic classes based on the specific UEs needs;
an INFaaS service of customized LLM inference for the UEs;
a GRaaS service of LLM guardrail management, to reinforce user request confidentiality; and/or
a LRaaS service of routing the user requests produced by the UEs to the most suitable language model for reducing the latency and/or improving the quality of service, QoS, and/or the relevance of answers to user requests;
and any combination of the above.

4. The processing architecture of claim 1, wherein the LLM inference services are descriptive files of an Infrastructure as Code, IaC, type.

5. The processing architecture of claim 1, wherein the service requests generated by the centralized orchestrator and the request operator implement Containerized Network Functions, CNFs, corresponding to the LLM inference services included in the on-demand service register.

6. The processing architecture of claim 5, wherein the CNFs corresponding to the LLM inference services are operated in a Network Functions Virtualisation, NFV, architecture, based on ETSI specifications.

7. The processing architecture of claim 1, wherein the UPF distributed network is an heterogeneous network comprising:
UPFs of main switching/routing function, and/or
UPFs comprising, in addition to the switching/routing functions, adjustable user-request pre-processing functions specific to the LLM applications.

8. The processing architecture of claim 1, wherein the UPF distributed network is a network comprising a dynamically adjustable number of UPFs.

9. The processing architecture of claim 1, wherein the UPFs are developed as micro-services deployed in cloud infrastructures in containers orchestrated by a container orchestrator.

10. The processing architecture of claim 1, wherein the UPFs are programmed in P4 language.

11. The processing architecture of claim 1, wherein the 5G network, the centralized orchestrator and the on-demand service register are implemented as containerized functions, which instantiation and life-cycle management on data center hardware infrastructure are managed by an container orchestrator.

12. The processing architecture of claim 9, wherein the container orchestrator is a Kubernetes solution, and the 5G network is an open source solution of a Free5gc or sd-core type.

13. The processing architecture of claim 1, wherein the user profiles and the LLM inference service usage models comprise at least one among:
frequency of use;
content popularity;
location and/or geographic mobility of the UEs;
quality of service, QoS, constraint;
latency constraint; and/or
interactions with other UEs;
and any combination of the above.

14. The processing architecture of claim 1, wherein said specific tasks related to the LLM inference executed locally by the UPFs comprise at least one among:
Recovery-Augmented Generation, RAG;
dynamic optimisation of user caches;
specific routing of the user requests;
calculation of similarity usage metrics between UEs;
clustering of input and/or output similar UE data; and/or
LLM inference operation;
and any combination of the above.

15. The processing architecture of claim 1, wherein the UEs are equipment devices of the group comprising smartphones, autonomous robots and/or video surveillance cameras, comprising a circuit for connection to the 5G network and which profile has already been entered into a core network user database.

16. The processing architecture of claim 11, wherein the container orchestrator is a Kubernetes solution, and the 5G network is an open source solution of a Free5gc or sd-core type.
